(19) United States
(12) Patent Application Publication
(10) Pub. No.: US 2018/0312314 A1
(43) Pub. Date: Nov. 1, 2018

(54) Packaging Material

(71) Applicant: Graphic Packaging International, LLC, Atlanta, GA (US)

(72) Inventors: Ryan Portrey, Louisville, CO (US); Alan Fontaine, Louisville, CO (US)

(21) Appl. No.: 15/963,419

(22) Filed: Apr. 26, 2018

Related U.S. Application Data
(60) Provisional application No. 62/490,701, filed on Apr. 27, 2017.

(51) Int. Cl. B65D 65/42; B05D 3/10; B05D 7/24; B05D 1/28; B05C 1/08

(52) U.S. Cl. CPC B65D 65/42; B05D 3/104; B05C 1/0817; B05D 1/28; B05C 1/0813; B05D 7/24

(57) ABSTRACT

A method for forming a packaging material. The method can comprise moving a web of material in a downstream direction. The web can comprise fibrous material. The method further can comprise applying a moisturizing liquid to the web to at least partially wet the fibrous material. The applying the moisturizing liquid to the web can comprise receiving the web in a moisturizing station comprising at least, a drive roller and a transfer roller. The receiving the web in the moisturizing station can comprise moving the web between the drive roller and the transfer roller, and the applying the moisturizing liquid to the web can comprise engaging a face of the fibrous material with the moisturizing liquid on the transfer roller. The method further can comprise forming a film on the web, which can comprise applying a film-forming liquid to the web.

### CROSS-REFERENCE TO RELATED APPLICATIONS

This application claims the benefit of U.S. Provisional Patent Application No. 62/490,701, filed on Apr. 27, 2017.

### INCORPORATION BY REFERENCE

The disclosure of U.S. Provisional Patent Application No. 62/490,701, which was filed Apr. 27, 2017, is hereby incorporated by reference for all purposes as if presented herein in their entirety.

### BACKGROUND OF THE DISCLOSURE

The present disclosure generally relates to packaging materials and systems and methods for making packaging materials that may include a porous base material and a film formed on the base material and may be formed into constructs such as blanks, cartons, press-formed constructs, or the like.

### SUMMARY OF THE DISCLOSURE

In general, one aspect of the disclosure is directed to a method for forming a packaging material. The method can comprise moving a web of material in a downstream direction. The web can comprise fibrous material. The method further can comprise applying a moisturizing liquid to the web to at least partially wet the fibrous material. The applying the moisturizing liquid to the web can comprise receiving the web in a moisturizing station comprising at least a drive roller and a transfer roller. The receiving the web in the moisturizing station can comprise moving the web between the drive roller and the transfer roller, and the applying the moisturizing liquid to the web can comprise engaging a face of the fibrous material with the moisturizing liquid on the transfer roller. The method further can comprise forming a film on the web, which can comprise applying a film-forming liquid to the web.

In another aspect, the disclosure is generally directed to a system for forming a packaging material. The system can comprise a moisturizing station receiving a web of material. The web can comprise fibrous material. The moisturizing station can comprise at least a drive roller, a transfer roller, and a moisturizing liquid on at least the transfer roller. The moisturizing station can receive the web between the drive roller and the transfer roller and the transfer roller can engage a face of the fibrous material with the moisturizing liquid for applying a moisturizing liquid to the web to at least partially wet the fibrous material to form an intermediate web. The system further can comprise a film-forming station for applying a film-forming liquid to the intermediate web for forming a film on the intermediate web.

In another aspect, the disclosure is generally directed to a method for forming a packaging material. The method can comprise moving a web of material in a downstream direction. The web can comprise fibrous material. The method further can comprise applying a moisturizing liquid to the web to at least partially wet the fibrous material at the first face. The applying the moisturizing liquid to the web can comprise receiving the web in a moisturizing station comprising at least a first drive roller and a first transfer roller, the receiving the web in the moisturizing station can comprise moving the web between the first drive roller and the first transfer roller, and the applying the moisturizing liquid to the web can comprise engaging a face of the fibrous material with the moisturizing liquid on the first transfer roller. The method also can comprise forming a film on the web, which can comprise receiving the web in a film-forming station comprising at least a second drive roller and a second transfer roller. The receiving the web in the film-forming station can comprise moving the web between the second drive roller and the second transfer roller, and the forming the film can comprise applying a film-forming liquid to the web by engaging the first face of the fibrous material with the film-forming liquid on the second transfer roller. The film can at least partially seal the first face of the fibrous material.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure. The drawings are schematic and exemplary only, and should not be construed as limiting the invention.

FIG. 1 is a schematic side view of a system for forming a packaging material in accordance with an exemplary embodiment of the disclosure.

FIG. 2A is a schematic cross-sectional view of a portion of an initial web of material in accordance with the exemplary embodiment.

FIG. 2B is a schematic cross-sectional view of a portion of an intermediate web of material in accordance with the exemplary embodiment.

FIG. 2C is a schematic cross-sectional view of a portion of a resultant web of packaging material in accordance with the exemplary embodiment.

FIG. 3 is a schematic perspective view of a moisturizing station of FIG. 1.

FIG. 4 is a schematic side elevation view of the moisturizing station of FIG. 3.

FIG. 5 is a schematic side elevation of a modified configuration of the moisturizing station of FIGS. 3 and 4.

Corresponding parts are designated by corresponding reference numbers throughout the drawings.

### DETAILED DESCRIPTION OF THE EXEMPLARY EMBODIMENTS

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the invention.

One aspect of this disclosure is the provision of systems and methods for providing a web of packaging material, wherein the packaging material may be formed into a tray, a carton, and/or another suitable container or construct for holding or packaging one or more articles (e.g., for storage, transporting, and/or use). In one example, the packaging material can be formed into a construct for use in cooking and/or reheating food in a microwave oven and can include microwave transparent and/or microwave energy interactive materials.

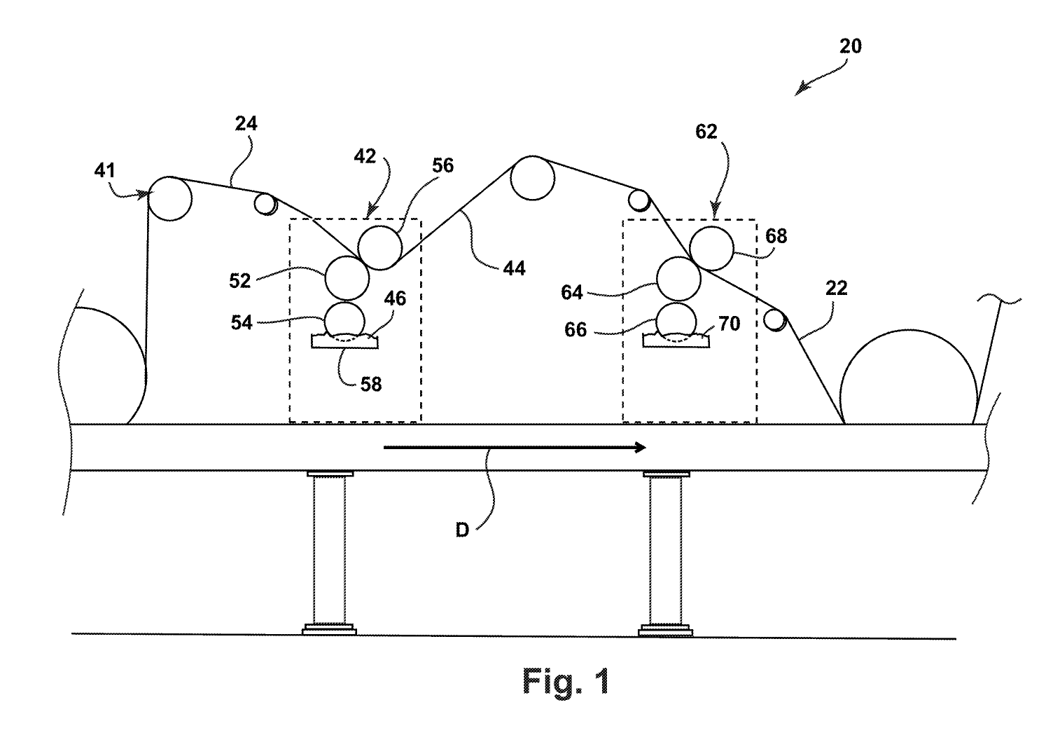

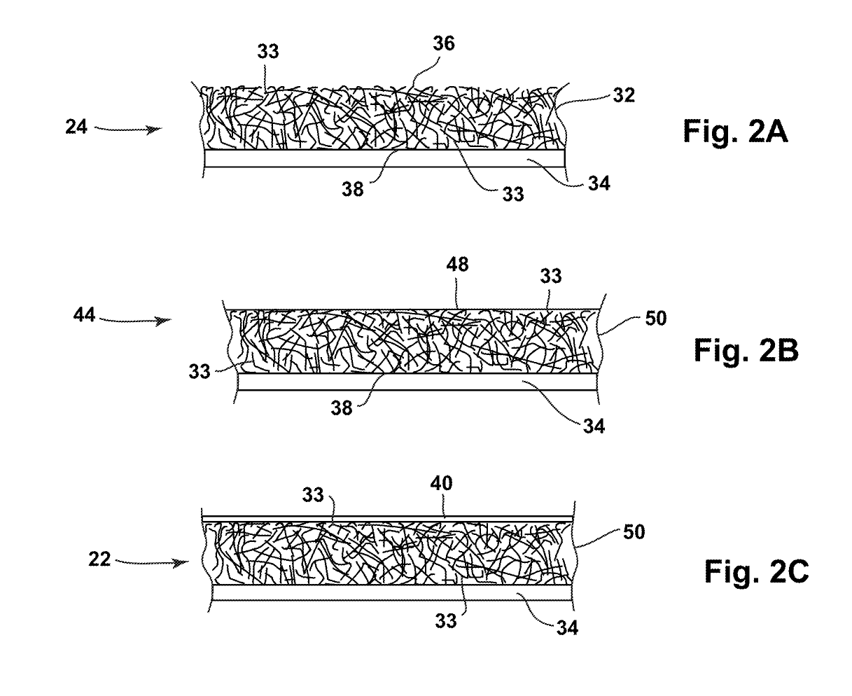

Referring now in greater detail to the drawings, initially FIG. 1, a system 20 and associated methods of an exemplary embodiment of this disclosure are described in the following. In the illustrated embodiment, the system 20 can have a downstream or machine direction D (FIG. 1). In accordance with one aspect of this disclosure, the system 20 and associated methods may be utilized in the fabrication of a packaging material 22 (FIGS. 1 and 2C) comprising a paperboard base material or other suitable fibrous material and a sealing layer. In one embodiment, the packaging material 22 can be in the form of a web (e.g., a resulting or resultant web). In the system 20 of the exemplary embodiment, there are several stages of the materials respectively associated with webs of material that are precursors to the packaging material 22. The precursor webs may include an initial web 24 (FIGS. 1 and 2A). The initial web 24 and/or the resultant web 22 could be otherwise configured without departing from the disclosure.

In the illustrated embodiment, the initial web 24 comprises a web of base material 32 (e.g., substrate) that is coated on one side with a coating 34 (FIG. 2A). For ease of readability, the web of base material 32 may be referred to as a base layer or base material 32 in the following. In one embodiment, the base layer 32 can be suitable for being formed into constructs such as, but not limited to, blanks, cartons, trays, bowls, press-formed constructs, or the like. The base material 32 can be paperboard or other suitable fibrous and/or porous material so that the base material is at least partially made up of one or more plies of fibers 33 (e.g., cellulose fibers) that can absorb liquid (e.g., via capillary action). The fibers 33 of the base material 32 are shown schematically in FIGS. 2A-2C. The base material 32 can have a first face 36 and a second face 38 as shown in FIG. 2A, and the coating 34 can be a clay coating or other suitable coating applied to the second face 38 of the base material 32. In one embodiment, the coating 34 can be suitable for printing graphics such as logos, designs, product information, advertising, price coding, and other information or images. Alternatively or in addition, the coating 34 can at least partially seal the second face 38 of the base material 32 against fluids (e.g., water, grease, oxygen). In one embodiment, the coating 34 can form an exterior surface of the packaging material 22. The base material 32 and/or the coating 34 could be otherwise shaped, arranged, positioned, and/or configured without departing from the disclosure.

According to a method of forming the packaging material 22 in one embodiment of the present disclosure, a coating or film can be formed on the first face 36 of the base web 32 (e.g., for sealing the first face 36 against liquids and/or gases, etc., and/or to apply a more even or uniform surface to the base material than the exposed fibers 33 of the base material). In one embodiment, a film 40 (FIG. 2C) can be formed by applying a film material to the first face 36 in liquid form and then allowing the film material (e.g., film-forming liquid) to form a coating or film. In one embodiment, the film can be a barrier layer 40 that at least partially forms a barrier or seal on a face of the packaging material 22, and the film material can be a sealing material or sealing liquid 70 (FIG. 1). In the illustrated embodiment, the first face 36 can have a generally non-uniform surface due to the fibers 33 of the base material so that applying a material (e.g., in liquid form) can result in an uneven coating surface. Additionally, the base layer 32 can be porous so that the fibers 33 can absorb some portion of the sealing liquid (e.g., by capillary action) and the resulting barrier layer may have gaps and/or an uneven thickness over the resulting web of packaging material 22.

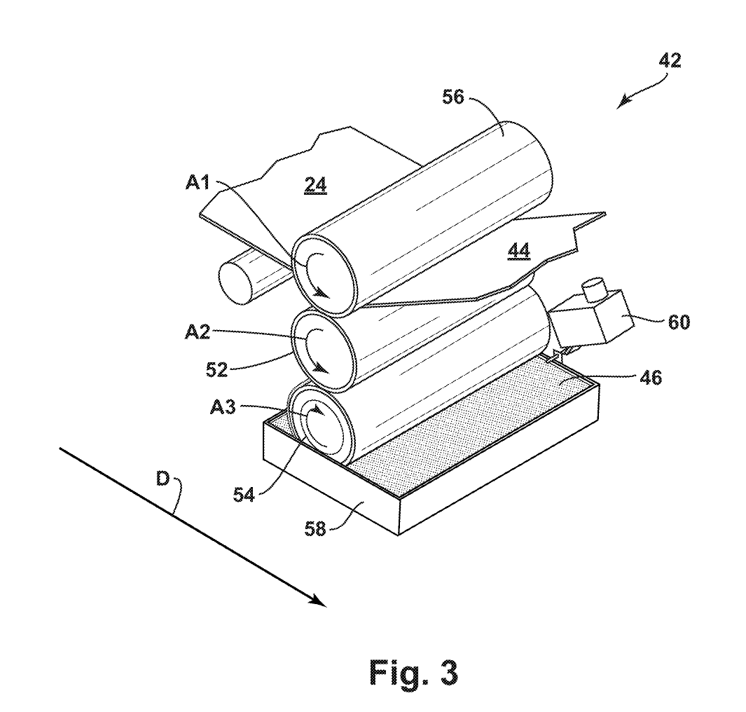

Accordingly, in the illustrated embodiment, the system 20 includes a web transport system 41, which can include a plurality of drive rollers, guide rollers, nip rollers, and/or other suitable features for moving the web of material through the system 20. Further, as shown in FIG. 1, the system 20 can include a moisturizing station 42 (e.g., a wetting station or a first station) (FIGS. 1 and 3-5) that can form an intermediate web 44 (FIG. 2B) from the initial web 24. As shown in FIGS. 3-5, the moisturizing station 42 can apply a moisturizing liquid 46 (e.g., comprising water and/or other suitable liquids, solutes, solids in suspension, etc.) to the base material 32 so that the fibers 33 of the base material 32 at least partially absorb the moisturizing liquid. In one exemplary embodiment, the moisturizing liquid 46 can include water and a paper lubricant such as PCL-500 available from Michelman, Inc. of Cincinnati, Ohio. Alternatively, the moisturizing liquid could include any suitable materials. Accordingly, the moisturizing liquid 46 can help form the first face 36 into a generally flat and/or uniform face 48 (e.g., an at least partially flat and/or uniform face) for applying the sealing liquid of the barrier layer 40 to the first face. Additionally, the moisturizing liquid 46 can take up a sufficient amount of the base material's capacity to absorb liquids to help reduce the absorption of the liquid sealing material applied to the first face 36 in the moisturizing station 42 (e.g., the moisturizing liquid 46 can reduce the porosity of the base layer 32). Accordingly, the moisturizing station 42 can wet or moisturize the base material 32 with the moisturizing liquid 46 to at least partially prepare the base material 32 and the first face 36 for receiving the sealing material 40. In the illustrated embodiment, the intermediate web 44 can include the combination of the base material 32 and the moisturizing liquid 46, which can form a moistened or moisturized base material 50 as shown in FIG. 2B.

As shown in FIG. 3, the moisturizing station 42 can include a transfer roller 52 (e.g., a hydrophilic chrome transfer roller) engaging a meter roller 54 (e.g., comprising a resilient material) and a backup or drive roller 56 (e.g., comprising a resilient material). In one embodiment, the transfer roller 52 can have a surface that is chemically treated and/or coated so that the surface is hydrophilic. As shown in FIG. 3, the meter roller 54 engages a supply of the moisturizing liquid 46, which can be contained in a tray 58 or other suitable container. In one embodiment, the meter roller 54 can be at least partially submerged in the moisturizing liquid 46. The moisturizing station 42 could be otherwise shaped, arranged, positioned, and/or configured without departing from the disclosure.

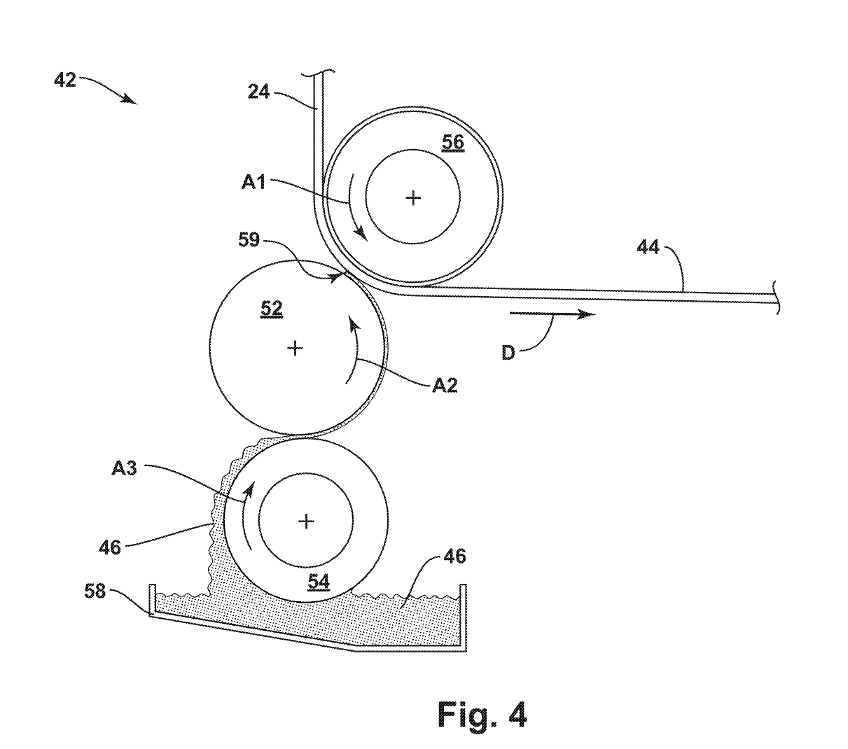

As shown in FIGS. 1 and 3, the system 20 can move the initial web 24 so that it enters the moisturizing station 42 and moves between the transfer roller 52 and the backup roller 56. In the illustrated embodiment, the backup roller 56 can rotate (e.g., in the direction of arrow A1 in FIGS. 3 and 4) so that the lower portion of the backup roller 56 that is in contact with the web is moving in the same direction as the web (e.g., generally in the downstream direction D). Stated another way, the web moves generally in the downstream direction D from left to right in FIGS. 1 and 3 and contacts a surface portion of the backup roller 56 at a lower side of the backup roller, and the backup roller rotates in a counterclockwise direction in FIGS. 1 and 3 so that the portion of the surface of the backup roller that contacts the web is moving generally in the downstream direction D. In one embodiment, the backup roller 56 can cooperate with the web transport system 41 to drive the web in the downstream direction D. As shown in FIGS. 3 and 4, the transfer roller 52 also can rotate in the counterclockwise direction (e.g., in the direction of arrow A2) so that the surface portion at an upper side of the transfer roller that engages or nearly engages the initial web 24 is moving generally opposite to the machine direction D. In the illustrated embodiment, the meter roller 54 can rotate in the clockwise direction (e.g., in the direction of arrow A3). In one embodiment, the meter roller 54 and the transfer roller 52 can contact one another at an upper portion of the meter roller 54 and a lower portion of the transfer roller 52, and the surfaces of the respective rollers can be moving generally in the same direction (e.g., generally in the machine direction D) at the point of engagement.

In the illustrated embodiment, as the meter roller 54 rotates, the surface of the meter roller 54 can move through the moisturizing liquid 46 (FIGS. 3 and 4). Subsequently, as the surface of the meter roller 54 rotates upwardly out of the supply bath of the moisturizing liquid 46, some of the moisturizing liquid can move upwardly with the surface of the meter roller and engage the surface of the transfer roller 52 (FIGS. 3 and 4). Accordingly, an amount (e.g., a thin film) of the moisturizing liquid 46 can be metered to the transfer roller 52. Nip pressure and differential speeds between the metering roller 54 and the transfer roller 52 can facilitate the metering of the moisturizing liquid 46 to the transfer roller 52 in one embodiment. The moisturizing liquid 46 that is transferred to the transfer roller 52 can move upwardly on the hydrophilic surface of the transfer roller 52 toward the initial web 24 and the backup roller 56 where the initial web 24 can engage the moisturizing liquid 46 as the initial web moves along the surface of the backup roller 56 between the backup roller and the transfer roller 52. In the illustrated embodiment, the surface portion of the transfer roller 52 is moving in the opposite direction to the initial web 24 at the point of contact 59, which can facilitate the moisturizing liquid 46 to impregnate the base layer 32 (e.g., via the first face 36) and moisturize the base layer 32. The speed of the transfer roller 52 and the nip setting of the meter roller 54 can determine the rate of moisturizing in one embodiment. A moisture sensor 60 can monitor the moisture content of the moisturized base layer 50 and adjust the speed of the transfer roller 52 as needed (e.g., the moisture sensor 60 can increase the speed of the transfer roller 52 to increase the moisturizing of the base layer). In one exemplary embodiment, the transfer roller 52 can rotate in the direction of arrow A2 at approximately 105% to approximately 110% of the speed that the backup roller 56 rotates in the direction of arrow A1 (FIGS. 3 and 4). Alternatively, the transfer roller 52, the meter roller 54, and/or the backup roller 56 could be configured with any suitable settings.

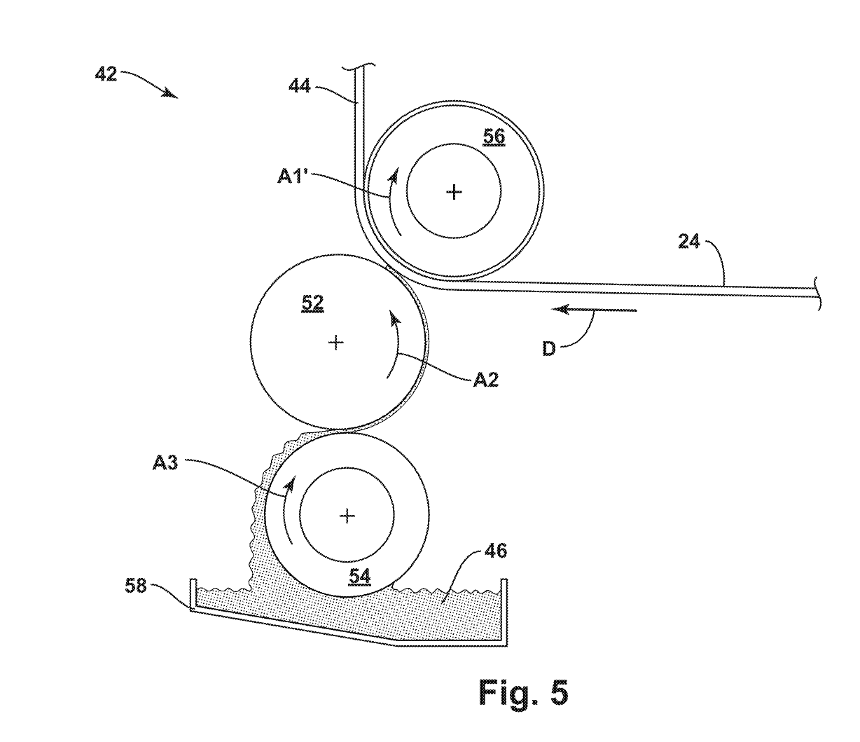

Accordingly, the intermediate web 44 with the moisturized base layer 50 can exit the moisturizing station 42 as shown in FIGS. 1 and 3. In one exemplary embodiment, the moisturized base layer 50 could be moisturized to be in the range of approximately 9 percent to approximately 12 percent. In a particular exemplary embodiment, the moisturized base layer 50 could be moisturized to approximately 10 percent. The intermediate web 44 could be otherwise pre-moisturized without departing from the disclosure. For example, as shown in FIG. 5, the direction that the initial web 24 moves into the moisturizing station 42 and the rotation of the backup roller 56 can be reversed (e.g., so that the backup roller 56 rotates in a clockwise direction in FIG. 5 in the direction of arrow A1′). Accordingly, in the embodiment of FIG. 5, the upper side of the transfer roller 52 (e.g., rotating in the counterclockwise direction as shown by arrow A2) can be moving in the same direction as the lower side of the backup roller 56 where the transfer roller 52, the moisturizing liquid 46, and/or the backup roller 56 engage the web. In the illustrated embodiment, the configuration shown in FIG. 5 can be considered a “forward roll moisturizing configuration” and the configuration shown in FIGS. 3 and 4 can be considered a “reverse roll moisturizing configuration.” In one embodiment, the system 20 can be configured to move the web generally in the machine direction D in both of the forward roll moisturizing configuration and the reverse roll moisturizing configuration. In an exemplary embodiment, the reverse roll moisturizing configuration of FIGS. 3 and 4 can result in a high application rate for moisturizing the base layer 32 (e.g., up to 3000 feet per minute or any other suitable rate) and the forward roll moisturizing configuration of FIG. 5 can have a relatively low application rate compared to the reverse roll moisturizing configuration. In an alternative embodiment, the backup roller 56 and the direction of the web could be as shown in FIGS. 3 and 4 and the transfer roller 52 and meter roller 54 could be reversed for a forward roll moisturizing configuration similar to the one shown in FIG. 5.

As shown in FIG. 1, the system 20 can include a sealing station 62 (e.g., a film-forming station, a coating station, or a second station) in line with the moisturizing station 42 so that the intermediate web 44 exits the moisturizing station 42 and enters the sealing station 62. Alternatively, the moisturizing station 42 and/or the sealing station 62 could be in separate systems and/or the intermediate web 44 can undergo additional processing and/or forming operations between the moisturizing station 42 and the sealing station 62. In the illustrated embodiment, the sealing station 62 can be configured in a similar or identical manner as the moisturizing station 42 with a transfer roller 64 engaging a meter roller 66 and a backup or drive roller 68 disposed opposite to the transfer roller 64. In one embodiment, the moisturizing station 42 can have a first transfer roller 52, a first meter roller 54, and a first backup roller 56 and the sealing station can have a second transfer roller 64, a second meter roller 66, and a second backup roller 68. In place of the moisturizing liquid 46 of the moisturizing station 42, the sealing station 62 can have a sealing liquid 70 (broadly: a film-forming liquid), which can be configured to form a film or coating on the moisturized base material 50 after being applied in liquid form in the sealing station 62. In one exemplary embodiment, the sealing liquid 70 can be a water-based material with solids (e.g., polyester and/or other suitable materials) in suspension or solution with the water so that the solids form the coating or film barrier layer 40 on the first face 48 of the moisturized base layer 32 as the water in the sealing liquid 70 dries, evaporates and/or otherwise leaves the face 48.

In the illustrated embodiment, the sealing station 62 forms the intermediate web 42 into the resultant web of packaging material 22 by applying the sealing liquid 70, which then forms the film 40 on the first face 48 (e.g., by drying). The sealing station 62 could be otherwise shaped, arranged, positioned, and/or configured without departing from the disclosure. For example, the sealing liquid could be any suitable material that can at least partially solidify to form the film 40. In alternative embodiments, the sealing station 62 could apply the sealing liquid with a simpler nip roller, in a spray, in a curtain, and/or in any other suitable manner.

As shown in FIG. 1, the resultant web 22 can exit the sealing station with the film 40 (FIG. 2C) and continue in the downstream direction D for further processing (e.g., application of additional coatings and/or other treatments, lamination, etc.), printing (e.g., flexographic, gravure, etc.), forming (e.g., molding, folding, cutting, forming fold lines, creases, cut lines, tear lines, etc.), and/or other suitable stations. Accordingly, the moisturizing station 42 and the sealing station 62 can be in line with other forming, processing, and/or printing stations for finishing the packaging material 22, which can save time and money with respect to offline systems for forming a barrier (e.g., lamination systems). In one embodiment, the moisturized base layer 50 can gradually dry (e.g., by evaporation of the moisturizing liquid 46 via exposed edges of the base layer and/or via the faces of the base layer).

In the illustrated embodiment, the configuration of the moisturizing station 42 and the sealing station 62 can allow the pre-moisturizing and the application of the film 40 to be fine-tuned, for example in order to adjust the barrier properties, the appearance, and/or other aspects of the film 40. For example, modifying the speed and/or direction of the rollers in the moisturizing station 42 and/or the sealing station 62 can help adjust the amount of moisture and/or coating material applied to the base material in the system 20. Accordingly, in one embodiment, the system 20 can be optimized so that the sealing liquid can be applied to the first face of the base layer and a sufficient amount of the sealing liquid can remain on the first face (e.g., instead of being absorbed into the base material) so that the sealing liquid can dry or otherwise form a film on the first face and create a sufficient barrier (e.g., against moisture, gases, etc.). In addition, in one embodiment, the system 20 can provide a cost savings over offline systems (e.g., since the system 20 can be integrated in line with existing printing systems and/or paperboard construct forming systems) while applying a consistent and effective barrier layer to the paperboard base material.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank. In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the carton to function at least generally as described herein. The blanks can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

In general, microwave ovens provide a convenient means of cooking and reheating food items. Many combinations of materials of different character have been used in microwave packaging to influence the effect of the microwave energy on the food product being heated. These microwave packaging materials may be microwave transparent, for example, paper, paperboard, or many plastics, or they may be microwave energy interactive, for example, metal foils or thin metal deposits. Microwave transparent materials generally provide, for example, food product support, packaging form, insulation, and/or vapor barrier functions in packaging. Microwave energy interactive material generally provides, for example, enhanced surface heating, microwave shielding, enhanced microwave transmission, and/or energy distribution functions in packaging.

Microwave packaging can be created and configured of both microwave transparent and microwave energy interactive materials. For example, MicroRite brand trays, which are available from Graphic Packaging International, Inc., comprise aluminum foil laminated to paperboard. The aluminum foil can be configured in predetermined shapes that define a pattern. In some embodiments, the shapes and/or pattern may be formed by chemically etching away (in a caustic bath) some of the foil and/or chemical deactivation of some of the foil. In some embodiments, the configuration of the microwave energy interactive material determines the performance characteristics of the microwave energy interactive material.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A method for forming a packaging material, the method comprising:
moving a web of material in a downstream direction, the web comprising fibrous material;
applying a moisturizing liquid to the web to at least partially wet the fibrous material, the applying the moisturizing liquid to the web comprising receiving the web in a moisturizing station comprising at least a drive roller and a transfer roller, the receiving the web in the moisturizing station comprising moving the web between the drive roller and the transfer roller, and the applying the moisturizing liquid to the web comprising engaging a face of the fibrous material with the moisturizing liquid on the transfer roller; and
forming a film on the web, the forming the film comprising applying a film-forming liquid to the web.

2. The method of claim 1, wherein the film forms a barrier layer for at least partially sealing the first face of the fibrous material.

3. The method of claim 2, wherein the film-forming liquid is a sealing liquid that at least partially forms the barrier layer on the web.

4. The method of claim 1, wherein the film-forming liquid comprises solid particles in liquid suspension and the solid particles at least partially form the film on the web as the liquid evaporates.

5. The method of claim 4, wherein the film-forming liquid is a water-based liquid and the solid particles comprise polyester particles.

6. The method of claim 1, wherein:
the drive roller is a first drive roller and the transfer roller is a first transfer roller;
the forming the film on the web comprises receiving the web in a sealing station comprising at least a second drive roller and a second transfer roller, the receiving the web in the sealing station comprising moving the web between the second drive roller and the second transfer roller; and
the forming the film comprising applying the film-forming liquid to the web by engaging the first face of the fibrous material with the film-forming liquid on the second transfer roller.

7. The method of claim 6, wherein each of the moisturizing liquid and the film-forming liquid comprises water, and each of the first transfer roller and the second transfer roller comprises a surface with a hydrophilic material.

8. The method of claim 6, wherein the moisturizing station comprises a first meter roller at least partially submerged in a supply of the moisturizing liquid, and the sealing station comprises a second meter roller at least partially submerged in a supply of the film-forming liquid, the first meter roller and the second meter roller engaging the respective first transfer roller and second transfer roller, the applying the moisturizing liquid to the web further comprising moving the moisturizing liquid on the first meter roller to the first transfer roller, and the applying the film-forming liquid to the web further comprising moving the film-forming liquid on the second meter roller to the second transfer roller.

9. The method of claim 1, wherein the moisturizing liquid comprises water, and the transfer roller comprises a surface with a hydrophilic material.

10. The method of claim 1, wherein the moisturizing station comprises a meter roller at least partially submerged in a supply of the moisturizing liquid, the meter roller engaging the transfer roller, and the applying the moisturizing liquid to the web further comprising moving the moisturizing liquid on the first meter roller to the first transfer roller.

11. The method of claim 10, wherein the meter roller engages the transfer roller and the meter roller and the transfer roller rotate in opposite directions.

12. The method of claim 1, wherein the transfer roller rotates so that a surface portion of the transfer roller that contacts the face of the fibrous material of the web moves in a first direction, and the drive roller moves the web in the first direction in the moisturizing station or in a second direction in the moisturizing station, the second direction being opposite to the first direction.

13. The method of claim 1, wherein the applying the moisturizing liquid to the web comprises moisturizing the fibrous material to be moisturized in the range of approximately 9 percent to approximately 12 percent.

14. The method of claim 1, wherein the applying the moisturizing liquid to the web moisturizes the fibrous material to help reduce the porosity of the fibrous material and to make the face of the fibrous material smoother.

15. The method of claim 1, wherein the fibrous material comprises paperboard, the paperboard having a clay coating on an outer surface opposite to the face of the fibrous material.

16. A resultant web comprising the packaging material formed by the method of claim 1.

17. A system for forming a packaging material, the system comprising:
a moisturizing station receiving a web of material, the web comprising fibrous material, the moisturizing station comprising at least a drive roller, a transfer roller, and a moisturizing liquid on at least the transfer roller, the moisturizing station receiving the web between the drive roller and the transfer roller and the transfer roller engaging a face of the fibrous material with the moisturizing liquid for applying a moisturizing liquid to the web to at least partially wet the fibrous material to form an intermediate web; and
a film-forming station for applying a film-forming liquid to the intermediate web for forming a film on the intermediate web.

18. The system of claim 17, wherein the film is for forming a barrier layer for at least partially sealing the first face of the fibrous material.

19. The system of claim 18, wherein the film-forming liquid is a sealing liquid for at least partially forming the barrier layer on the intermediate web.

20. The system of claim 17, wherein the film-forming liquid comprises solid particles in liquid suspension and the solid particles are for at least partially forming the film on the web as the liquid evaporates.

21. The system of claim 20, wherein the film-forming liquid is a water-based liquid and the solid particles comprise polyester particles.

22. The system of claim 17, wherein:
the drive roller is a first drive roller and the transfer roller is a first transfer roller; and
the film-forming station comprises a sealing station comprising at least a second drive roller and a second transfer roller, the sealing station receives the intermediate web and moves the intermediate web between the second drive roller and the second transfer roller, the second transfer roller engaging the face of the fibrous material with the film-forming liquid for applying the film-forming liquid to the intermediate web.

23. The system of claim 22, wherein each of the moisturizing liquid and the film-forming liquid comprises water, and each of the first transfer roller and the second transfer roller comprises a surface with a hydrophilic material.

24. The system of claim 22, wherein the moisturizing station comprises a first meter roller at least partially submerged in a supply of the moisturizing liquid, and the sealing station comprises a second meter roller at least partially submerged in a supply of the film-forming liquid, the first meter roller and the second meter roller engaging the respective first transfer roller and second transfer roller for moving the respective moisturizing liquid and film-forming liquid to the respective first transfer roller and second transfer roller.

25. The system of claim 17, wherein the moisturizing liquid comprises water, and the transfer roller comprises a surface with a hydrophilic material.

26. The system of claim 17, wherein the moisturizing station comprises a meter roller at least partially submerged in a supply of the moisturizing liquid, the meter roller engaging the transfer roller for moving the moisturizing liquid to the transfer roller.

27. The system of claim 26, wherein the meter roller engages the transfer roller and the meter roller and the transfer roller rotate in opposite directions.

28. The system of claim 17, wherein the transfer roller rotates so that a surface portion of the transfer roller that contacts the face of the fibrous material of the web moves in a first direction, and the drive roller moves the web in the first direction in the moisturizing station or in a second direction in the moisturizing station, the second direction being opposite to the first direction.

29. The system of claim 17, wherein the fibrous material comprises paperboard, the paperboard having a clay coating on an outer surface opposite to the face of the fibrous material.

30. The system of claim 17, further comprising a web transport system that moves the web of material in the downstream direction.

31. A method for forming a packaging material, the method comprising:
moving a web of material in a downstream direction, the web comprising fibrous material;
applying a moisturizing liquid to the web to at least partially wet the fibrous material at the first face, the applying the moisturizing liquid to the web comprising receiving the web in a moisturizing station comprising at least a first drive roller and a first transfer roller, the receiving the web in the moisturizing station comprising moving the web between the first drive roller and the first transfer roller, and the applying the moisturizing liquid to the web comprising engaging a face of the fibrous material with the moisturizing liquid on the first transfer roller;
forming a film on the web, the forming the film comprising receiving the web in a film-forming station comprising at least a second drive roller and a second transfer roller, the receiving the web in the film-forming station comprising moving the web between the second drive roller and the second transfer roller, and the forming the film comprising applying a film-forming liquid to the web by engaging the first face of the fibrous material with the film-forming liquid on the second transfer roller, wherein the film at least partially seals the first face of the fibrous material.
